(19) United States
(12) Patent Application Publication
(10) Pub. No.: US 2008/0120328 A1
(43) Pub. Date: May 22, 2008

(54) Method of Performing a Weight-Based Search

(75) Inventors: Lior Delgo, Los Altos, CA (US); Eitan Sharon, San Mateo, CA (US); Shai Deljo, Palo Alto, CA (US)

Correspondence Address: FULBRIGHT & JAWORSKI;MARKET SQUARE, 801 PENNSLYVANIA, N.W., WASHINGTON, DC, 200042604, US

(73) Assignee: REXEE, INC., San Mateo, CA (US)

(21) Appl. No.: 11/687,300

(22) Filed: Mar. 16, 2007

Related U.S. Application Data
(60) Provisional application No. 60/869,271, filed on Dec. 8, 2006.
(60) Provisional application No. 60/869,279, filed on Dec. 8, 2006.
(60) Provisional application No. 60/866,552, filed on Nov. 20, 2006.

(51) Int. Cl. G06F 17/30

(52) U.S. Cl. 707/102; 707/E17.001

(57) ABSTRACT

A method assigns tags to and descriptive of content. Assigned to the tags are respective weights with respect to the content. The tags and associated weights may be stored in a memory. The weights may be indicative of an importance of the tags to respective portions of the content. The content may be any of a wide range of content and/or file types including, but not limited to, video, audio, text and signal files. Highlights corresponding to selected portions of the files may be identified and provided for user review. The stored information may be searched based on search terms associated with tags together with the weights to be associated with each tag, the weights indicative of an importance of items identified by corresponding tags with respect to the identified content.

### CROSS REFERENCE TO RELATED APPLICATIONS

This application claims priority under 35 U.S.C. § 119(e) of U.S. Provisional Application Nos. 60/869,271 and 60/869,279 filed Dec. 8, 2006 and 60/866,552 filed Nov. 20, 2006 and is related to Ser. No. 11/______ (attorney docket no. 680.010) entitled Apparatus for Performing a Weight-Based Search and Ser. No. 11/______ (attorney docket no. 680.012) entitled Computer Program Implementing a Weight-Based Search by the inventors of the present application; and U.S. patent application Ser. Nos. 11/______ (attorney docket no. 680.008) entitled Method of Performing Motion-Based Object Extraction and Tacking in Video and 11/______ (attorney docket no. 680.013) entitled Computer Program and Apparatus for Motion-Based Object Extraction and Tacking in Video and by Eitan Sharon et al. all of which non-provisional applications were filed on Mar. 16, 2007 contemporaneously herewith, all of the previously cited provisional and non-provisional applications being incorporated herein by reference in their entireties.

### FIELD OF THE INVENTION

The invention is directed to searching content including video and multimedia and, more particularly, to a weight-based search of content.

### BACKGROUND

The prior art includes various searching methods and systems directed to identifying and retrieving content based on key words found in the file name, tags on associated web pages, transcripts, text of hyperlinks pointing to the content, etc. Such search methods rely on Boolean operators indicative of the presence or absence of search terms. However, a more robust search method is required to identify content satisfying search requirements.

### SUMMARY OF THE INVENTION

The invention is directed to a robust search method providing for enhanced searching of content taking into consideration not only the existence (or absence) of certain characteristics (as might be indicated by corresponding “tags” attached to the content or portions thereof, e.g., files), but the importance of those characteristics with respect to the content. Tags may name or describe a feature, quality of, and/or objects associated with the content (e.g., video file) and/or of objects appearing in the content (e.g., an object appearing within a video file and/or associated with one or more objects appearing in a video file and/or associated with objects appearing in the video file.)

Search results, whether or not based on search criteria specifying importance values, may include importance values for the tags that were searched for and identified within the content. Additional tags (e.g., tags not part of the preceding queried search terms) may also be provided and displayed to the user including, for example, tags for other characteristics suggested by the preceding search and/or suggested tags that might be useful as part of a subsequent search. Suggested tags may be based in part on past search histories, user profile information, etc. and/or may be directed to related products and/or services suggested by the prior search or search results.

Results of searches may further include a display of thumbnails corresponding and linking to content most closely satisfying search criteria, the thumbnails arranged in order of match quality with the size of the thumbnail indicative of its match quality (e.g., best matching video files indicated by large thumbnail images, next best by intermediate size thumbnails, etc.) A user may click on and/or hover over a thumbnail to enlarge the thumbnail, be presented with a preview of the content (e.g., a video clip most relevant to the search terms and criteria) and/or to retrieve or otherwise access the content.

While the following description of a preferred embodiment of the invention uses an example based on indexing and searching of video content, e.g., video files, visual objects, etc., embodiments of the invention are equally applicable to processing, organizing, storing and searching a wide range of content types including video, audio, text and signal files. Thus, an audio embodiment may be used to provide a searchable database of and search audio files for speech, music, or other audio types for desired characteristics of specified importance. Likewise, embodiments may be directed to content in the form of or represented by text, signals, etc.

According to an aspect of the invention, a method comprising the steps of assigning tags to and descriptive of content, assigning, to the tags, respective weights with respect to the content, and storing the tags and associated weights in a memory. The step of assigning respective weights may include determining an importance of the tags to respective portions of the content. The content may comprise a plurality of video, audio, text and/or signal files, at least one of the tags being assigned to each of the files.

According to a feature of the invention, a highlight segment may be identified within the content.

According to another feature of the invention, a clickable thumbnail representing and linking to the content may be created.

According to another feature of the invention, information may be identified and stored (i) for retrieving the content, (ii) identifying objects within the content, and (iii) weights for each of the objects associated with the content.

According to another feature of the invention, metadata associated with and characterizing the content may be identified and stored.

According to another feature of the invention, the tags may include information including, but not limited to, content (i) type, (ii) location, (iii) title, (iv) description, (v) author, (vi) creation date, (vii) duration, (viii) quality, (ix) size, and/or (x) format.

According to another feature of the invention, the content may be segmented so as to extract objects that may then be tracked thought the content and/or assigned tags and associated weights. Assigning tags may include recognizing at least one of the objects and, in response, assigning one of the tags to the object.

According to another feature of the invention, a time-space thread may be created for each of the objects, the objects being tracked and/or recognized throughout the content (e.g., within a contiguous file).

According to another feature of the invention, assigning weights to each of the tags may include identification of relative features of the objects within the content including, but not limited to, (i) object duration, (ii) size, (iii) dominant motion, (iv) photometric features, (v) focus, (vi) screen position, (vii) shape, and/or (viii) texture.

Additional objects, advantages and novel features of the invention will be set forth in part in the description which follows, and in part will become apparent to those skilled in the art upon examination of the following and the accompanying drawings or may be learned by practice of the invention. The objects and advantages of the invention may be realized and attained by means of the instrumentalities and combinations particularly pointed out in the appended claims.

### BRIEF DESCRIPTION OF THE DRAWINGS

The drawing figures depict preferred embodiments of the present invention by way of example, not by way of limitations. In the figures, like reference numerals refer to the same or similar elements.

FIG. 1 is a flow chart of a method of processing content to segment, tag, and associate weights with the content and various components thereof;

FIG. 2 is a flow chart of a method searching for and retrieving content based on weighted search terms;

FIG. 3 is a screen shot of a user interface used to identify a video to be processed and indexed;

FIG. 4 is a screen shot of a user interface displaying a video that has been uploaded for processing and providing input fields for receiving descriptive information about the video;

FIG. 5 is a screen shot of a user interface used to designate an object appearing in a video;

FIG. 6 is a screen shot of a user interface used to enter information about a designated object;

FIG. 7 is a screen shot of a user interface used to assign and/or adjust weights associated with respective object tags and to associate links and open text with the object;

FIG. 8 a screen shot of a user interface used to add a highlight for a video;

FIG. 9 is a screen shot of an interface allowing a user to view thumbnails of the first and last frames of a highlight and provide a name for the highlight;

FIG. 10 is a screen shot of a user interface depicting a recently added highlight;

FIG. 11 is a screen shot of a user interface displaying an array of popular searches and providing a text box for a user to enter search terms for conducting a search of available video content;

FIG. 12 is a screen shot of a user interface displaying video thumbnails resulting from a search together with initial weights associated with each search term and suggested (associative) terms;

FIG. 13 is a screen shot of a user interface displaying video thumbnails of a revised set of videos resulting from user adjustment of weighting values assigned to the various search terms;

FIG. 14 is a screen shot of a user interface displaying designation of a video by a user “rolling over” an associated thumbnail;

FIG. 15 is a screen shot of a user interface displaying a revised set of videos resulting from user deletion of one of the search results;

FIG. 16 is a screen shot of a simplified user interface used to input search terms and adjust search parameters; and

FIG. 17 is a block diagram of a computer platform for executing computer program code implementing processes and steps according to various embodiments of the invention.

### DETAILED DESCRIPTION OF THE PREFERRED EMBODIMENTS

While the following preferred embodiment of the invention uses an example based on indexing and searching of video content, e.g., video files, visual objects, etc., embodiments of the invention are equally applicable to processing, organizing, storing and searching a wide range of content types including video, audio, text and signal files. Thus, an audio embodiment may be used to provide a searchable database of and search audio files for speech, music, etc. Likewise, embodiments may be directed to content in the form of or represented by text, signals, etc.

Embodiment of the invention include, among other things, methods for processing content represented in a wide range of formats including, for example, video, audio, waveforms, etc. so as to identify object present in the content, tag the content and the objects identified, identify weights indicating an importance of the tag and/or related object within the context of the content, and provide a searchable database used to identify and retrieve content satisfying specified search criteria. Further embodiments of the invention provide methods for supporting and/or performing a weighted search of such a database.

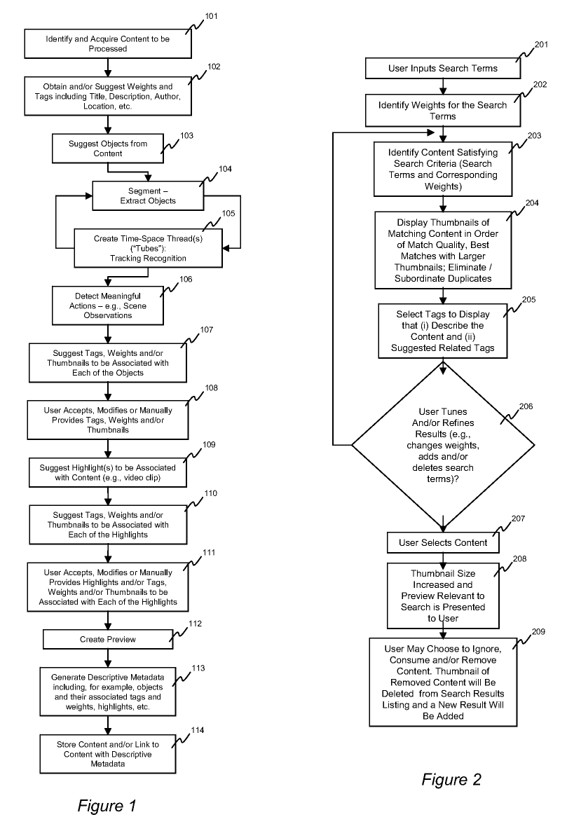

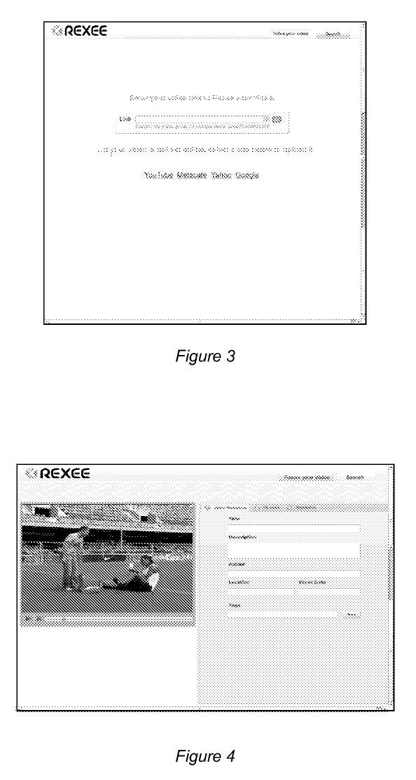

With reference to FIG. 1 of the drawings, an embodiment of the invention directed to a method of processing content in the form of videos will be described including segmentation, tagging and associating weights with the content and various components thereof. Thus, at step 101 content to be processed is identified and acquired. For example, with reference to FIG. 3, a user interface may be provided allowing a user to select a video file and/or identify a link pointing to a video file (e.g., a URL or Uniform Resource Locator). At step 102 information about the video can be provided using, for example, the user interface illustrated in FIG. 4. Descriptive information may include video metadata such as the Title of the video, a narrative description, author, location and shoot date of the video, and any tags (and associated weights) to be associated with the video. The interface may include a viewer for displaying the video as processed.

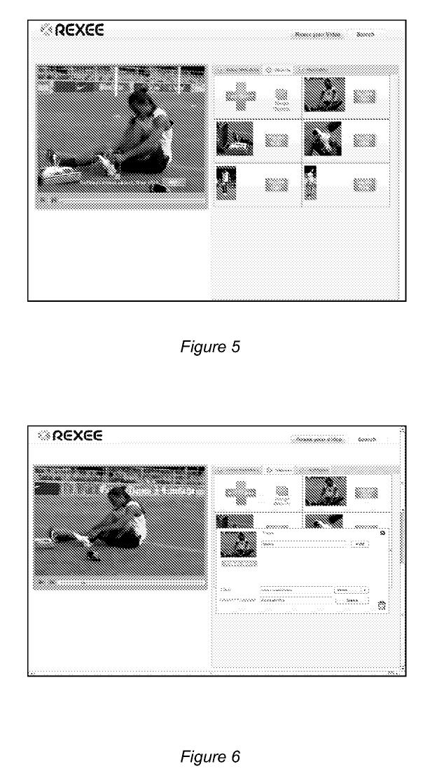

Objects within the content being or to be processed may be identified at step 103. Object identification may be initiated automatically or manually by a user designating a region of interest. Once a region of interest has been designated, step 104 segments frames of the video while step 105 creates time-space threads or “tubes” that track objects across multiple frames. Thus, as shown in FIG. 5, various objects have been identified as represented by the corresponding thumbnails shown on the right portion of the display screen, either automatically or upon user initiation. Using the “Add Object” button, a user may designate a region of interest using the viewer and a graphic input device (e.g., a mouse) to delineate of “fence” an area of the image. The region of interest is then processed to identify an object within the region and a tube to represent the region is created. The newly created tube can be merged with other tubes or be a part of another tube.

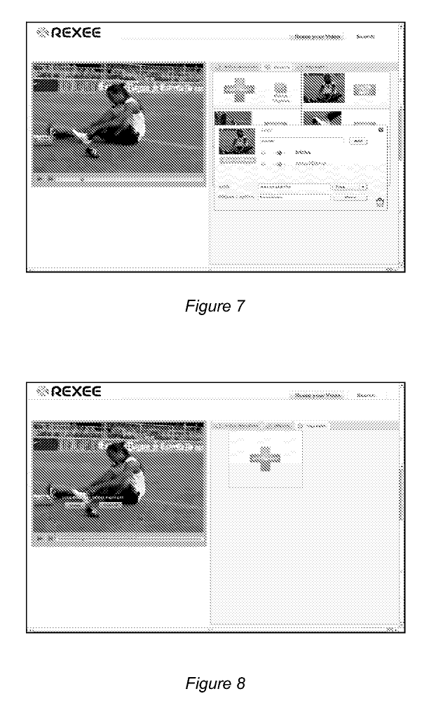

Once appearing in the thumbnails, suggested tags, weights and/or alternative thumbnail images may be associated with an object as provided by step 107. This information may be provided automatically or, at step 108, the user may modify or manually designate this information. User intervention may be provided by use of the “Tag Me Now” buttons shown in FIG. 5 that may cause a popup window to appear. The popup window may include a thumbnail of the object and text fields for the entry and/or display of metadata associated with the object such as the name of the associated tag, links, object caption, free or open text description of the object, etc. As tags are designated and associated with the object, the tags may appear in the popup window as shown in FIG. 7. Adjacent each tag designation a slider may indicate an initial importance or weight value associated with each tag and further provide for user adjustment of the weight value. Weight values may correspond to the importance attributed to a tag and/or the associated object within the context of the video. For example, in the context of a video clip about a soccer player, a name tag associated with the soccer player “object” (i.e., the image of the soccer player) as depicted in the video may be regarded as highly important and be given a large weight value. Alternatively, an object corresponding to a soccer shoe may be a relatively minor part of the video and be assigned a low weight value. These weight values may be automatically determined by criteria such as the length of time the object (in this case, image(s) of the soccer player and shoe) appears in the video, relative motion of the object indicating, for example, visual tracking of and/or centering on the object, the amount of space within the image occupied by the object, etc. Once determined, the calculated, default or manually designated weight value may be represented by the position of the slider depicted in FIG. 7. A user may then adjust the weight value(s) using the sliders as appropriate.

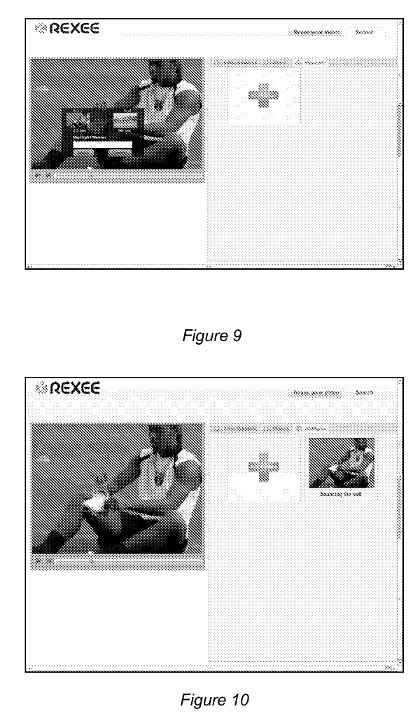

Steps 109-111 provide for the creation of Highlights as supported by, for example, the user interfaces of FIGS. 8-10. Referring to FIG. 1, at step 109 processing is performed to suggest one or more highlights to be associated with the content, e.g., video segments representative of the video as a whole and/or of particular objects appearing in the video. This process may be manually initiated by the user via an “Add Highlight” button as shown in FIG. 8. The user may designate start and end frames by setting corresponding arrows on a slider at the bottom of the video player. Once the start and end points are designated, a popup window displays thumbnails corresponding to the start and end frames and provides a text entry field to input the name of the highlight as shown in FIG. 9. Pushing the “Done” button results in the highlight being added as shown in FIG. 10. As with videos and objects within the video, thumbnails, tags and weights may be associated with each highlight as provided by step 110. Step 111 provides for user acceptance and/or modification of the highlights, tags, weights and/or thumbnails.

Step 112 creates a preview of the content. The preview may correspond to a designated highlight. At step 113 processing continues to generate descriptive metadata associated with the content (e.g., video) including, for example, designation of objects and their associated tags and weights, highlights, duration of time during which an object appears, etc. The content or link to the content and the associated metadata and other information generated and/or collected during the previous steps may then be stored in a searchable database at step 114.

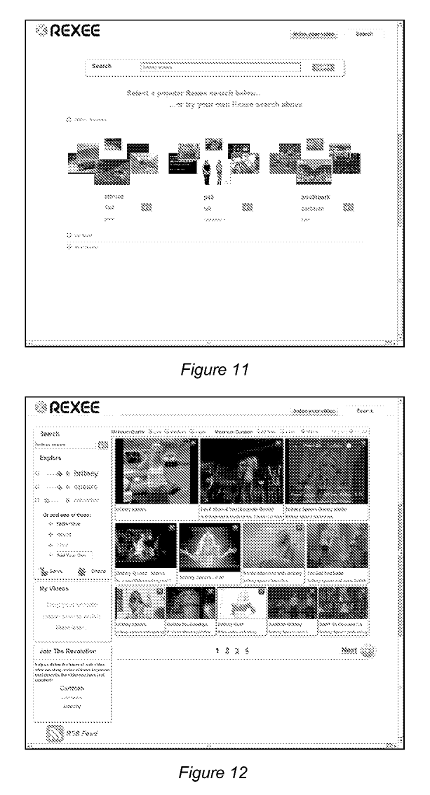

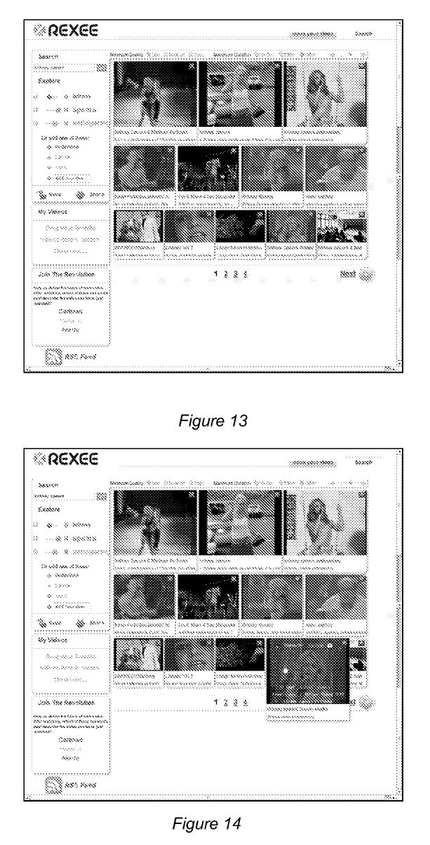

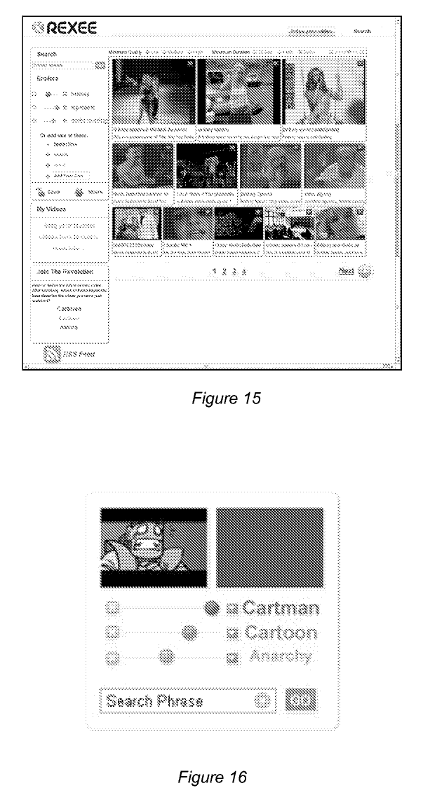

A method of searching for and retrieving content is depicted by the flow chart of FIG. 2. At step 201 a user inputs search terms associated with content to be located. An example of a suitable interface is shown in the screen shot of FIG. 11 including a text entry field for inputting search terms. The interface may include other features such as, for example, popular searches that may be of interest to the user as depicted by the three groups of rotating thumbnail images in the middle of the screen with the associated tag identifiers listed below each group of thumbnails. At step 202 the system and/or user may identify weights, i.e. an importance level, for each of the search terms. Step 203 identifies content satisfying the search criteria, that is, content responsive to the search terms and, if provided, weight values for tags associated with the search terms and displayed at step 204. For example, with reference to FIG. 12, a number of thumbnails corresponding to videos identified by the search may be displayed to the user on a portion of a video display. The thumbnails may be arranged in order of match quality, with the largest thumbnails corresponding to best matches, content of lower match confidence levels being displayed afterwards and with smaller thumbnails, etc. Tags associated with the videos may be identified and displayed to the user (step 205) together with their corresponding weights (e.g., as present in the videos identified, calculated to be responsive to the search terms entered, or otherwise identified). The weights may be associated with means to adjust the weights such as my use of respective slider controls as depicted in the upper left portion of FIG. 12. In addition to tags corresponding to the entered search terms, additional and/or alternate tags may be identified and made available for inclusion in adjusting and/or refining the search as also shown in FIG. 12 (see “Or add one of these”). As the user deletes, adds and/or modifies the weights associated with the tags, the system updates the search and resulting thumbnails as shown in FIG. 13.

Step 207 provides for user selection of content. This may be accomplished by using a pointing device, such as a mouse, to designate a thumbnail corresponding to the desired content among those identified by the search. One implementation detects a cursor position so that, as the user “rolls-over” a thumbnail, it becomes active as indicated by its increased size (step 208) and the display of additional options (e.g., controls to watch a clip of the video, go to a content provider to access the full the video, delete the video from the search results, etc.) and information about the video (e.g., length, etc.) as shown in the screen shot of FIG. 14. Step 209 provides for editing of the list of search results including replacement of thumbnails of deleted search results with thumbnails of other, previously nondisplayed, video(s).

FIG. 16 is a screen shot of a simplified user interface used to input search terms and adjust search parameters. This implementation may be used when screen real estate (i.e., usable display area) is limited. In this case, a single thumbnail corresponding to a best match may be displayed together with sliders associated with weight values of the associated tags.

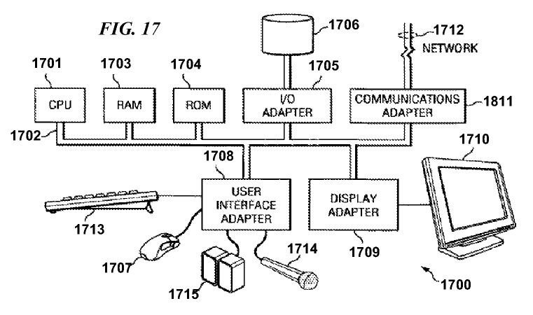

FIG. 17 is a block diagram of a computer platform for executing computer program code implementing processes and steps according to various embodiments of the invention. Object processing and database searching may be performed by computer system 1700 in which central processing unit (CPU) 1701 is coupled to system bus 1702. CPU 1701 may be any general purpose CPU. The present invention is not restricted by the architecture of CPU 1701 (or other components of exemplary system 1700) as long as CPU 1701 (and other components of system 1700) supports the inventive operations as described herein. CPU 1701 may execute the various logical instructions according to embodiments of the present invention. For example, CPU 1701 may execute machine-level instructions according to the exemplary operational flows described above in conjunction with FIGS. 1 and 2.

Computer system 1700 also preferably includes random access memory (RAM) 1703, which may be SRAM, DRAM, SDRAM, or the like. Computer system 1700 preferably includes read-only memory (ROM) 1704 which may be PROM, EPROM, EEPROM, or the like. RAM 1703 and ROM 1704 hold/store user and system data and programs, such as a machine-readable and/or executable program of instructions for object extraction and/or video indexing according to embodiments of the present invention.

Computer system 1700 also preferably includes input/output (I/O) adapter 1705, communications adapter 1711, user interface adapter 1708, and display adapter 1709. I/O adapter 1705, user interface adapter 1708, and/or communications adapter 1711 may, in certain embodiments, enable a user to interact with computer system 1700 in order to input information.

I/O adapter 1705 preferably connects to storage device(s) 1706, such as one or more of hard drive, compact disc (CD) drive, floppy disk drive, tape drive, etc. to computer system 1700. The storage devices may be utilized when RAM 1703 is insufficient for the memory requirements associated with storing data for operations of the system (e.g., storage of videos and related information). Although RAM 1703, ROM 1704 and/or storage device(s) 1706 may include media suitable for storing a program of instructions for video process, object extraction and/or video indexing according to embodiments of the present invention, those having removable media may also be used to load the program and/or bulk data such as large video files.

Communications adapter 1711 is preferably adapted to couple computer system 1700 to network 1712, which may enable information to be input to and/or output from system 1700 via such network 1712 (e.g., the Internet or other wide-area network, a local-area network, a public or private switched telephony network, a wireless network, any combination of the foregoing). For instance, users identifying or otherwise supplying a video for processing may remotely input access information or video files to system 1700 via network 1712 from a remote computer. User interface adapter 1708 couples user input devices, such as keyboard 1713, pointing device 1707, and microphone 1714 and/or output devices, such as speaker(s) 1715 to computer system 1700. Display adapter 1709 is driven by CPU 1701 to control the display on display device 1710 to, for example, display information regarding a video being processed and providing for interaction of a local user or system operator during object extraction and/or video indexing operations.

It shall be appreciated that the present invention is not limited to the architecture of system 1700. For example, any suitable processor-based device may be utilized for implementing object extraction and video indexing, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

While the foregoing has described what are considered to be the best mode and/or other preferred embodiments of the invention, it is understood that various modifications may be made therein and that the invention may be implemented in various forms and embodiments, and that it may be applied in numerous applications, only some of which have been described herein. It is intended by the following claims to claim any and all modifications and variations that fall within the true scope of the inventive concepts. For example, embodiments and/or implementations of the invention may include a weighted pricing and/or object bidding feature. Such a feature supports paid advertising that may be included as part of and/or incorporated into a video.

Currently most advertisers pay the same amount to all consumers coming via paid ads (CPC) from the same property. There are some variations of methods, which take into account the qualification of a user based on previous activities on the property and other demographic/geographic elements. For example if a user is found to have searched more times for the same term he/she will be considered more qualified (e.g., interested in a corresponding product or service) and therefore advertisers will be willing to pay more for that specific link. Existing application of this method are quite limited. For example, advertisers may be limited to textual campaigns, i.e. they can only bid using text terms.

A weighted pricing and object bidding feature may use the previously described weight based index system to capture and collect information about how important each term/element is in the content. This data can then be used to support a dynamic pricing mechanism for selling links and/or advertising to a customer (e.g., to the advertiser) based on the level of importance associated with the inquiry by the user (e.g., person initiating a search or inquiry). According to such a system, an advertiser may be able to bid different prices (for a specific term) for different relative weights of the term in the search query, where the assumption is that the higher the weight of the term in the query is, the more qualified the user is and the higher the CPC the advertiser is willing to pay. In addition, such a system and method may allow an advertiser to place a bid with an image/object. The advertiser is then able to upload an image of an item/object and place a bid for his advertisement to show up every time this item appears in a video, web page etc.

It should also be noted and understood that all publications, patents and patent applications mentioned in this specification are indicative of the level of skill in the art to which the invention pertains. All publications, patents and patent applications are herein incorporated by reference to the same extent as if each individual publication, patent or patent application was specifically and individually indicated to be incorporated by reference in its entirety.

1. A method comprising the steps of:
assigning tags to and descriptive of content;
assigning, to said tags, respective weights with respect to said content; and
storing said tags and associated weights in a memory.

2. The method according to claim 1 wherein said step of assigning, to said tags, respective weights includes determining an importance of said tags to respective portions of said content.

3. The method according to claim 1 wherein said content comprises a plurality of video files and at least one of said tags is assigned to each of said video files.

4. The method according to claim 1 wherein said content comprises a plurality of audio files and at least one of said tags is assigned to each of said audio files.

5. The method according to claim 1 wherein said content comprises a plurality of text files and at least one of said tags is assigned to each of said text files.

6. The method according to claim 1 wherein said content comprises a plurality of signal files and at least one of said tags is assigned to each of said signal files.

7. The method according to claim 1 further comprising a step of identifying a highlight segment within the content.

8. The method according to claim 1 further comprising a step of creating a clickable thumbnail representing and linking to said content.

9. The method according to claim 1 further comprising a step of storing information (i) for retrieving said content, (ii) identifying objects within said content, and (iii) weights for each of said objects associated with said content.

10. The method according to claim 1 further comprising a step of storing metadata associated with and characterizing said content.

11. The method according to claim 1 wherein said tags include information selected from the set consisting of content (i) type, (ii) location, (iii) title, (iv) description, (v) author, (vi) creation date, (vii) duration, (viii) quality, (ix) size, and (x) format.

12. The method according to claim 1 further comprising the steps of:
segmenting said content to extract objects;
tracking said objects through the content; and
assigning tags and associated weights to each of said objects.

13. The method according to claim 12 wherein said step of assigning tags includes a step of recognizing at least one of said objects and, in response, assigning one of said tags to said object.

14. The method according to claim 12 further comprising a step of creating a time-space thread for each of said objects including said step of tracking said objects and further comprising recognizing said objects through said content.

15. The method according to claim 12 wherein said step of assigning weights to each of said tags includes relative features of said objects within said content selected from said set consisting of (i) object duration, (ii) size, (iii) dominant motion, (iv) photometric features, (v) focus, (vi) screen position, (vii) shape, and (viii) texture.

16. The method according to claim 12 further comprising a step of extracting actions of the objects.

17. A method comprising the steps of:
segmenting content to extract objects;
tracking said objects through the content; and
assigning tags and associated weights to each of said objects.

18. The method according to claim 17 wherein said step of assigning tags and associated weights includes a step of recognizing at least one of said objects and, in response, associating a corresponding tag with said object.

19. The method according to claim 17 further comprising a step of creating a time-space thread for each of said objects including said step of tracking said objects and further comprising recognizing said objects through said content.

20. The method according to claim 17 wherein said content comprises a plurality of video files and said objects each comprise a coherent video object.

21. The method according to claim 17 wherein said content comprises a plurality of audio files and said objects each comprise a coherent audio object.

22. The method according to claim 17 wherein said content comprises a plurality of text files and said objects each comprise a coherent text object.

23. The method according to claim 17 wherein said content comprises a plurality of signal files and said objects each comprise a coherent signal object.

24. The method according to claim 17 wherein said step of assigning weights to each of said objects includes relative features of said objects within said content selected from said set consisting of (i) object duration, (ii) size, (iii) dominant motion, (iv) photometric features, (v) focus, (vi) screen position, (vii) shape, and (viii) texture.

25. A method of searching content comprising the steps of:
specifying search criteria including describing characteristics and associated importance values of said characteristics with respect to the content;
searching a plurality of tags for said characteristics and associated weights, said weights qualitatively linking each of said tags to associated portions of said content based on an importance of said characteristic within said portion of content; and
identifying at least one portion of said content most closely matching said search criteria.

26. The method according to claim 25 wherein said content comprises a plurality of video files and said portion of said content comprises at least one of said video files.

27. The method according to claim 25 further comprising a step of displaying said portion of said content.

28. The method according to claim 25 wherein said portion of said content comprises a plurality of files, said method further comprising a step of displaying representations of said files arranged in a decreasing match quality order.

29. The method according to claim 25 wherein said portion of said content comprises a plurality of files, said method further comprising a step of displaying thumbnails of said files such that a size of each of said thumbnails is representative a quality of match of an associated one of said files.

30. The method according to claim 25 wherein said portion of said content comprises a plurality of files, said method further comprising the step of eliminating duplicate listings of said files.

31. The method according to claim 25 further comprising a step of displaying additional tags associated with said portion of said content together with importance values associated with each of said additional tags.

32. The method according to claim 25 further comprising the steps of processing user input adjusting said importance values to provide user adjusted importance values and, in response, initiating a search of said content for tags corresponding to said characteristics with said user adjusted importance values.

33. The method according to claim 25 wherein the content comprises a plurality of video files and target objects each comprise a coherent video object.

34. The method according to claim 25 wherein the content comprises a plurality of audio files and said target objects each comprise a coherent audio object.

35. The method according to claim 25 wherein the content comprises a plurality of text files and said target objects each comprise a coherent text object.

36. The method according to claim 25 wherein the content comprises a plurality of signal files and said portion of said target objects each comprise a coherent signal object.

37. A method comprising the steps of:
identifying a first set of video files satisfying search criteria with respect to specified search terms;
displaying a listing of tags corresponding to said first set of video files together with associated weight values associated with each of said tags;
refining said search criteria by adjusting at least one of said weight values; and
identifying a second set of video files satisfying said refined match.

38. The method according to claim 37 further comprising the step of:
displaying thumbnails for a subset of at least one of said first and second sets of video files;
deleting from the display, in response to user input, one of said thumbnails; and
inserting a new thumbnail into said display.

39. The method according to claim 38 further comprising the step of displaying thumbnails of said second set of video files arranged in an order corresponding to match quality.

40. The method according to claim 39 further comprising a step of adjusting a size of said thumbnails in response to said match quality.

41. The method according to claim 37 further comprising a step of selecting ones of said tags to display.

42. The method according to claim 37 further comprising a step of, in response to said step of identifying said first set of video files, suggesting tags to be included as new search terms.
